(19) United States
(12) Patent Application Publication
(10) Pub. No.: US 2020/0172071 A1
(43) Pub. Date: Jun. 4, 2020

(54) ELECTRIC BRAKE BOOSTER

(71) Applicants: HYUNDAI MOTOR COMPANY, Seoul (KR); KIA MOTORS CORPORATION, Seoul (KR)

(72) Inventors: Joung-Hee Lee, Hwaseong-si (KR); Gwan-Hyeong Cha, Seoul (KR); Gab-Bae Jeon, Hwaseong-si (KR); Se-Ra Hwang, Suwon-si (KR)

(73) Assignees: HYUNDAI MOTOR COMPANY, Seoul (KR); KIA MOTORS CORPORATION, Seoul (KR)

(21) Appl. No.: 16/453,756

(22) Filed: Jun. 26, 2019

(30) Foreign Application Priority Data
Nov. 14, 2018 (KR) 10-2018-0140267

(51) Int. Cl. B60T 13/14; B60T 13/40; B60T 13/58; B60T 13/66

(52) U.S. Cl. CPC B60T 13/146; B60T 13/66; B60T 13/58; B60T 13/403

(57) ABSTRACT

An electric brake booster includes: a first pressure device, which generates brake fluid pressure via manipulation of a brake pedal; a second pressure device, which is connected to the first pressure device through a flow path at one side of the second pressure device, receives brake fluid pressure from the first pressure device, and receives driving power of a motor connected to another side of the second pressure device; a sensing unit mounted in the motor and measuring a displacement of the brake pedal and a rotation angle of the motor; and a buffer device connected to the second pressure device and preventing an increase in pressure of the brake pedal when the motor does not operate, in which motor rotation is controlled with a displacement of the brake pedal.

### CROSS-REFERENCE TO RELATED APPLICATIONS

This application claims priority under 35 U.S.C. § 119 to Korean Patent Application No. 10-2018-0140267, filed on Nov. 14, 2018 in the Korean Intellectual Property Office, the disclosure of which is incorporated herein by reference in its entirety.

### BACKGROUND

### 1. Field of the Disclosure

The present disclosure relates to an electric brake booster for a vehicle, and particularly, to an electric brake booster which performs both a function of a modulator for applying different brake pressure to four wheels and a function of boosting a brake pedal effort generated as a driver manipulates a brake pedal. The electric brake booster also ensures redundancy of an actuator in order to prepare for autonomous driving of a vehicle.

### 2. Description of the Related Art

In general, most vehicles are mounted with power-assisted brake devices such as power brakes that allow a driver to decelerate or completely stop the vehicle even though the driver presses the pedal with a comparatively small effort.

This configuration may be implemented by providing a brake device for a vehicle with a vacuum brake booster or a hydraulic brake booster as well as a hydraulic pressure transmission mechanism and thus providing brake assist power from the brake booster.

In this regard, Korean Patent No. 10-0947379, entitled “Brake Safety Device for Vacuum Brake Booster” in the related art, relates to a brake safety device for a vacuum brake booster and discloses the brake safety device for a vacuum brake booster which enables the vacuum brake booster to operate even though a vacuum pump for supplying compressed air to the vacuum brake booster breaks down.

However, the vacuum brake booster in the related art has a problem in that a separate electronic or mechanical vacuum pump needs to be additionally applied in a case in which a vacuum in an engine is insufficient.

The vacuum brake booster in the related art has a problem in that it is impossible to perform active braking in a state in which a driver does not apply the brake.

In this case, Korean Patent Application Laid-Open No. 10-2015-0022439, entitled “Electric Booster Type Braking System and Method of Controlling the Same”, discloses an electric booster type braking system and a method of controlling the same which perform uniform and stable control by initializing a mechanical origin position of a piston provided in the electric booster type braking system.

However, the electro-hydraulic booster in the related art does not include a structure that buffers the reaction force being applied to a brake pedal of a driver when a motor breaks down or an operation of the motor is delayed. As a result, there is a problem in that the driver is inconvenienced when braking the vehicle.

In the electro-hydraulic booster in the related art, a sub-master cylinder, which generates pressure when a driver manipulates a brake pedal, and a master cylinder, which receives pressure generated by an operation of a motor and receives the pressure from the sub-master cylinder, are formed in a straight line.

For this reason, the booster needs to be installed to be necessarily adjacent to the brake pedal. As a result, there are problems since the mounting position is limited, and it is difficult to ensure a gap at the periphery.

### SUMMARY

The present disclosure is made in an effort to provide an electric brake booster, in which a pedal cylinder, which is separated from a stationary sensor and a master cylinder, is mounted in a brake booster in the related art to simplify a layout of the booster. A structure for buffering a pressure variation is applied to improve a braking performance of a driver when a motor does not operate or there is a limitation when the motor assists a pedal effort.

An embodiment of the present disclosure provides an electric brake booster. The electric brake booster includes a first pressure device, which generates brake fluid pressure in accordance with a manipulation of a brake pedal. The electric brake booster further includes a second pressure device. The second pressure device is connected to the first pressure device through a flow path formed at one side of the second pressure device, receives the brake fluid pressure from the first pressure device, and receives driving power of a motor as the motor connected to another side of the second pressure device operates. The electric brake booster also includes a sensing unit which is mounted in the motor and measures a displacement of the brake pedal and a rotation angle of the motor. The electric brake booster further includes a buffer device, which is connected to the second pressure device and prevents an increase in pressure of the brake pedal when the motor does not operate. The rotation of the motor is controlled in accordance with a displacement of the brake pedal.

The first pressure device may further include a push rod, which is rectilinearly moved in accordance with the manipulation of the brake pedal. The first pressure device may also include a pedal piston which has one end coupled to the push rod and another end connected to a return spring such that the pedal piston reciprocally moves in accordance with the rectilinear motion of the push rod. The first pressure device may further include a pedal cylinder, which receives a brake fluid from an oil reservoir and generates pressure by the reciprocating motion of the pedal piston.

The second pressure device may further include a boosting cylinder, which is connected to the first pressure device through a flow path. The second pressure device may also include a screw, which is coupled to the motor and rotated in the boosting cylinder in accordance with the operation of the motor. The second pressure device may further include a nut, which is coupled to the screw and rectilinearly moved in accordance with the rotational motion of the screw. The second pressure device may also include a master piston, which has one side in contact with the nut and another side connected to a return spring such that the master piston reciprocally moves in accordance with the rectilinear motion of the nut. The second pressure device may further include a master cylinder, which receives a brake fluid from an oil reservoir and generates pressure by the reciprocating motion of the master piston.

The second pressure device may be connected to an Electronic Stability Control (ESC) module or a brake caliper through a flow path formed in the master cylinder.

The sensing unit may further include a pedal sensor, which measures a displacement of the brake pedal. The sensing unit may also include a motor sensor, which is mounted in the motor and measures a rotation angle of the motor.

The pedal sensor may measure a displacement of any one of the brake pedal, a push rod, and a pedal piston.

The buffer device may further include a pressure adjusting cylinder, which is connected to a master cylinder of the second pressure device through a flow path. The buffer device may also include a pressure adjusting piston, which has a reaction force spring mounted at a lower end of the pressure adjusting piston and reciprocally moves in the pressure adjusting cylinder in accordance with the brake fluid pressure generated by the first pressure device.

According to the present disclosure configured as described above, there are advantages in that with the simplified configuration of the flow paths, costs are reduced, and a probability of a breakdown is decreased.

According to the present disclosure, the ESC is utilized as an auxiliary actuator. As a result, there is an advantage in that redundancy of the actuator is ensured when the booster breaks down.

According to the present disclosure, the stationary sensor is applied. As a result, there are advantages in that the size of the booster may be reduced, which is advantageous to a layout configuration and collision performance.

According to the present disclosure, the pedal cylinder and the master cylinder are separately configured through the flow paths. As a result, there are advantages in that a degree of design freedom is improved and gaps between peripheral components are ensured.

According to the present disclosure, the structure for buffering a pressure variation is applied. As a result, there are advantages in that it is possible to mitigate a sense of difference of the pedal when a response of the motor is delayed, when the motor does not operate, and when there is a limitation in assisting the motor.

### BRIEF DESCRIPTION OF THE DRAWINGS

FIG. 1 is a view illustrating a state in which an electric booster in the related art operates.

FIG. 2 is a view illustrating an electric brake booster of the present disclosure.

FIG. 3 is a view illustrating an effective area AA of FIG. 2.

FIG. 4A is a view illustrating pressure applied to an effective area A1 of a master piston according to the present disclosure when a driver manipulates a brake pedal.

FIG. 4B is a view illustrating pressure applied to an effective area A2 of the master piston according to the present disclosure when a motor operates.

FIG. 4C is a view illustrating pressure applied to the effective area of AA of the master piston according to the present disclosure when the driver manipulates the brake pedal and the motor operates.

FIG. 5A is a graph illustrating a change in pedal effort with respect to a change in pedal stroke when a response of the motor is delayed.

FIG. 5B is a graph illustrating a change in pedal effort with respect to a change in pedal stroke when force of the motor reaches a limit point.

### DETAILED DESCRIPTION

Hereinafter, the present disclosure is described in detail with reference to the accompanying drawings. However, the present disclosure is not restricted or limited by the embodiments. Like reference numerals indicated in the respective drawings refer to members, which perform substantially the same functions.

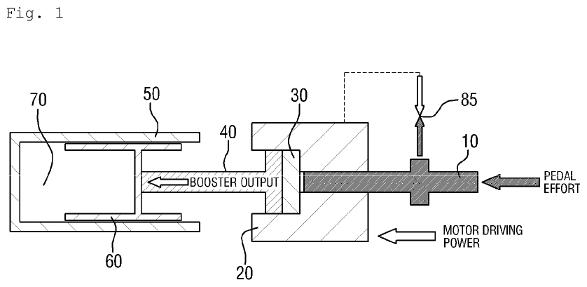

FIG. 1 is a view illustrating a state in which an electric booster in the related art operates.

Referring to FIG. 1, the electric booster in the related art includes a pedal rod 10 which transmits a pedal effort generated when a driver manipulates a brake pedal. The electric booster in the related art further includes a reaction disc 30, which is made of a rubber material and deformed depending on a state of force balance between a boosting body 20 and the pedal rod 10. The electric booster in the related art also includes a booster rod 40, which transmits an output of the booster to a piston 60. The electric booster in the related art further includes a chamber 50, which defines a cylinder 70.

The electric booster in the related art includes the reaction disc 30, which is deformed depending on the state of force balance. A mobile displacement measuring sensor 85 is used to measure and compare a displacement of the boosting body 20 and a relative displacement of the pedal.

The pedal effort, which is generated when the driver manipulates the brake pedal, needs to be transmitted to the booster without involvement of the brake fluid. As a result, the booster in the related art is installed close to a back surface of the pedal.

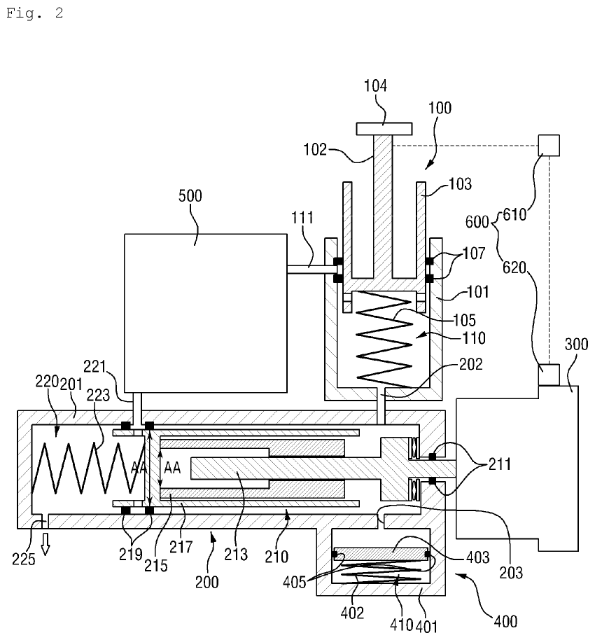

FIG. 2 is a view illustrating an electric brake booster according to the present disclosure.

Referring to FIG. 2, the electric brake booster according to the present disclosure may include a first pressure device 100, which generates hydraulic pressure by using a force of a brake pedal 104. The electric brake booster may further include a second pressure device 200, which generates hydraulic pressure by using a clamping force of a nut 215, which is generated by a driving power of a motor 300. The electric brake booster may also include a sensing unit 600, which compares and controls a displacement of a pedal piston 103 and a displacement of the nut 215. The electric brake booster may further include a buffer device 400, which reduces a situation in which the pressure of the first pressure device 100 and the pressure of the second pressure device 200 are rapidly changed.

The first pressure device 100 may be connected to the brake pedal 104 and may generate brake fluid pressure in accordance with the manipulation of the brake pedal 104. The first pressure device 100 may include a push rod 102 in a first chamber 101, the pedal piston 103, and a pedal cylinder 110.

The push rod 102 may be rectilinearly moved forward or rearward as the driver manipulates the brake pedal 104.

One end of the pedal piston 103 may be coupled to the push rod 102, such that the pedal piston 103 is reciprocally moved in accordance with the forward/rearward movements of the push rod 102. Another end, i.e., the other end of the pedal piston 103 may be connected to a return spring 105, such that the pedal piston 103 returns back to the original position.

The pedal cylinder 110 defines a space that constitutes the interior of the first chamber 101. The interior of the pedal cylinder 110 is filled with a brake fluid supplied from an oil reservoir 500 through a flow path 111 connected to the oil reservoir 500. The pedal cylinder 110 may generate brake fluid pressure by the reciprocating motion of the pedal piston 103.

In this case, the pedal piston 103 is reciprocally moved in the first chamber 101 while having a predetermined gap from the first chamber 101.

Seals 107 are provided at an upper side of the first chamber 101 and adjacent to the flow path 111 and disposed in the gap between the pedal piston 103 and the first chamber 101 in order to prevent a leakage of the brake fluid and generate pressure in the pedal cylinder 110.

The second pressure device 200 may be connected to the first pressure device through a flow path 202 formed at one side of the second pressure device 200 and receives the brake fluid pressure of the first pressure device 100. The second pressure device 200 may receive the driving power of the motor 300 as the motor 300 connected to another side of the second pressure device 200 operates.

The second pressure device 200 may include a boosting cylinder 210 in a second chamber 201, a screw 213, a nut 215, a master piston 217, and a master cylinder 220.

The second pressure device 200 may be connected to an ESC module or a brake caliper through a flow path 225 formed in the master cylinder 220.

In other words, the second pressure device 200 may transmit, to the ESC module or the brake caliper, pressure made by adding the driving power of the motor 300 and the pedal effort, which is transmitted from the first pressure device 100 and generated as the driver manipulates the brake pedal 104.

If a defect occurs in the second pressure device 200 and thereby the electric brake booster according to the present disclosure does not operate, the ESC module, which serves as an auxiliary actuator, may perform braking.

The boosting cylinder 210 is connected to the pedal cylinder 110 of the first pressure device 100 through the flow path 202. The brake fluid in the pedal cylinder 110 is delivered to the boosting cylinder 210, such that the pedal cylinder 110 and the boosting cylinder 210 have the same pressure.

The boosting cylinder 210 is not restricted in terms of a mounting position thereof as long as the flow path 202 is configured to connect the pedal cylinder 110 and the boosting cylinder 210 such that the boosting cylinder 210 is configured to indirectly receive, through the flow path 202, the brake pressure by means of the brake fluid pressure generated in the pedal cylinder 110. As a result, according to the electric brake booster according to the present disclosure, the entire layout of the booster including the master cylinder 220 or the motor 300 may be freely configured.

The screw 213 is coupled to the motor 300 and rotated in the boosting cylinder 210 in accordance with the operation of the motor 300. The nut 215 is coupled to the screw 213 so as to surround a circumferential surface of the screw 213, such that the nut 215 may be rectilinearly moved in the boosting cylinder 210 in accordance with the rotational motion of the screw 213.

In this case, a portion of the screw 213, which is coupled to the motor 300, may be formed in a T shape so that the screw 213 and the nut 215 are prevented from being decoupled from each other by the rectilinear motion of the nut 215. The screw 213 is coupled to the cylindrical nut 215 so as to be rotated in the boosting cylinder 210.

The second chamber 201 has a hole having a predetermined width so that the motor 300 and the screw 213 are coupled to each other. A seal 211, which seals a gap between the screw 213 and the second chamber 201, is provided on the screw 213 and in the hole formed in the second chamber 201, thereby preventing a leakage of the brake fluid and generating pressure in the boosting cylinder 210.

One side of the master piston 217 is in contact with the nut 215. Therefore, when the screw 213 is rotated by the rotation of the motor 300 and thus the nut 215 is moved forward, the master piston 217 may also be moved forward by force of the nut 215 pushing the master piston 217. In addition, the other side of the master piston 217 is connected to a return spring 223, such that the master piston 217 may return back to the original position while reciprocally moving.

The master cylinder 220 may receive the brake fluid from the oil reservoir 500 through a flow path 221 connected to the oil reservoir 500. The master cylinder 220 may generate pressure by the reciprocating motion of the master piston 217.

Seals 219 are formed to seal a gap between the master piston 217 and the second chamber 201, such that the pressure of the master cylinder 220 and the pressure of the boosting cylinder 210 may be different from each other.

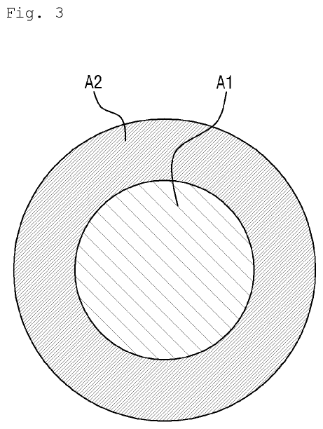

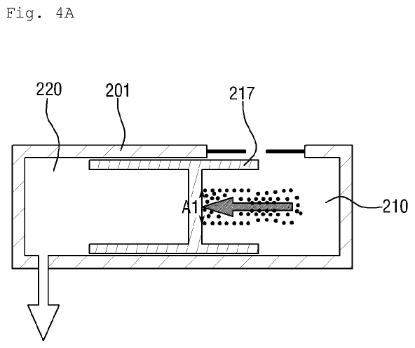

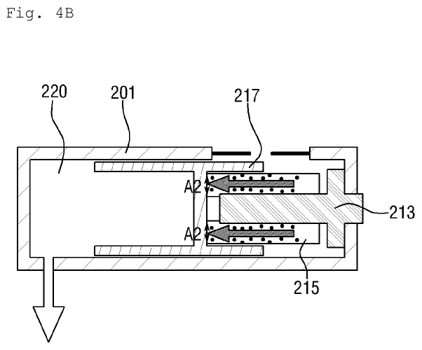

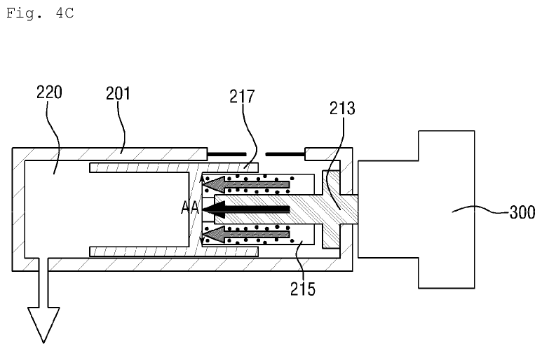

FIG. 3 is a view illustrating an effective area AA of FIG. 2. FIG. 4A is a view illustrating pressure applied to an effective area A1 of the master piston 217 according to the present disclosure when the driver manipulates the brake pedal. FIG. 4B is a view illustrating pressure applied to an effective area A2 of the master piston 217 according to the present disclosure when the motor 300 operates. FIG. 4C is a view illustrating pressure applied to the effective area AA of the master piston 217 according to the present disclosure when the driver manipulates the brake pedal and the motor 300 operates.

Referring to FIG. 3 and FIGS. 4A-4C, the clamping force of the nut 215, which is generated by the driving power of the motor 300, is transmitted to a portion corresponding to a contact area between the master piston 217 and the nut 215. Simultaneously, the pressure generated by the pedal cylinder 110 is applied to an effective area AA of the master piston 217.

Therefore, as illustrated in FIG. 4C, an output of the booster to be transmitted to the ESC module or the brake caliper is the sum of the clamping force of the nut 215 and the force made by multiplying the pressure of the pedal cylinder 110 by the effective area AA of the master piston 217.

The sensing 600 unit includes a pedal sensor 610, which measures a displacement of the brake pedal 104, and a motor sensor 620, which is mounted in the motor 300 and measures a rotation angle of the motor 300. The sensing unit 600 may measure the displacement of the brake pedal 104 and the rotation angle of the motor 300.

The pedal sensor 610 may measure the displacement of any one of the brake pedal 104, the push rod 102, and the pedal piston 103. In this case, the pedal sensor 610 detects an absolute displacement instead of a relative position of any one of the brake pedal 104, the push rod 102, and the pedal piston 103 with respect to another of the brake pedal 104, the push rod 102, and the pedal piston 103. As a result, a stationary sensor may be utilized as the pedal sensor 610.

The amount of change in volume of the pedal cylinder 110 is calculated based on the absolute displacement of the brake pedal 104 measured by the pedal sensor 610. A movement distance of the nut 215 is controlled so that the amount of change in volume of the master cylinder 220 is generated as much as the amount of change in volume of the pedal cylinder 110, such that a boost ratio between the pedal effort generated as the driver manipulates the brake pedal 104 and the pressure generated by the driving power of the motor 300 may be controlled.

In this case, the movement distance of the nut 215 may be calculated based on the rotation angle of the motor 300, which is measured by the motor sensor 620 mounted in the motor 300. Consequently, the rotation amount of the motor 300 may be determined depending on the displacement of the brake pedal 104 in order to control the brake boost ratio.

As shown in FIG. 2, the buffer device 400 is positioned in a third chamber 401 and connected to the second pressure device 200, thereby preventing an increase in pressure of the brake pedal 104 when the motor 300 does not operate or the operation of the motor 300 is delayed. The buffer device 400 may include a pressure adjusting cylinder 410, which is connected to the master cylinder 220 of the second pressure device 200 through a flow path 203. The buffer device 400 may further include a pressure adjusting piston 403, which has a reaction force spring 402 mounted at a lower end of the pressure adjusting piston 403 and reciprocally moves in the pressure adjusting cylinder 410 in accordance with the brake fluid pressure generated by the first pressure device 100.

A seal 405 is formed to seal a gap between the pressure adjusting piston 403 and the third chamber 401, such that the pressure adjusting cylinder 410 may have pressure different from pressure of the boosting cylinder 210.

A position of the pressure adjusting cylinder 410 is moved in accordance with a change in pressure of the pedal cylinder 110 and the boosting cylinder 210. A reaction force spring 402 mounted on the pressure adjusting cylinder 410 is configured as spring or a rubber material. The reaction force spring 402 prevents the pressure in the pedal cylinder 110 and the boosting cylinder 210 from being rapidly changed, thereby assisting a braking performance.

The material of the reaction force spring 401 may be rubber, a spring, or a combination thereof depending on the desired purpose.

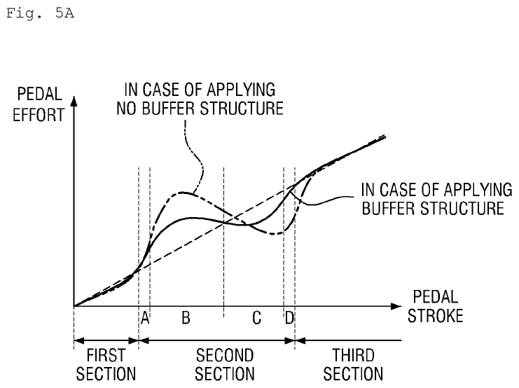

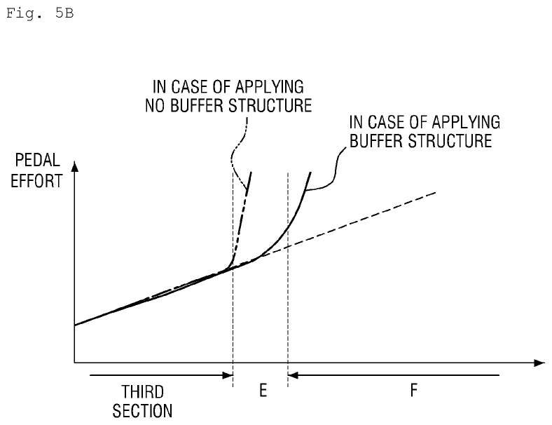

FIG. 5A is a graph illustrating a change in pedal effort with respect to a change in pedal stroke when a response of the motor 300 is delayed.

Referring to FIG. 5A, a case in which no buffer structure including the buffer device 400 according to the present disclosure is included and a case in which the buffer structure including the buffer device 400 according to the present disclosure is included may be compared in terms of the change in pedal effort with respect to the change in pedal stroke.

In the case in which no buffer structure is included, the push rod 102 and the pedal piston 103 are pressed as the driver presses the brake pedal 104, and therefore, the return spring 105 is compressed. In this case, if the response of the motor 300 is delayed or the motor 300 does not operate, only the pressure, which is generated in the pedal cylinder 110, is transmitted to the master piston 217 even though the control is performed by comparing the displacement of the pedal piston 103 and the displacement of the nut 215. Therefore, the nut 215, which performs no motion, and the master piston 217 are spaced apart from each other. Thereby, the pressure in the pedal cylinder 110 is rapidly increased.

As indicated in the second section in the graph, overshoot occurs together with the rapid increase in pressure in the pedal cylinder 110. As a result, a time delay occurs until the pedal effort reaches a predetermined target value.

In a case in which the driver attempts to manipulate the brake pedal 104 in this situation, it is not easy to manipulate the brake pedal 104 because of the increase in pressure of the pedal cylinder 110.

In contrast, in the case in which the buffer structure is included, if the response of the motor 300 is delayed or the motor 300 does not operate, the brake pedal effort is increased to a level equal to the initial force of the reaction force spring 402 (A section). However, thereafter, the reaction force spring 402 is compressed, and therefore, the pressure adjusting piston 403 is moved downward, such that the increase in pressure in the pedal cylinder 110 is mitigated (B section).

The brake pedal effort is increased until the brake pedal effort reaches the initial force of the reaction force spring 402. Rigidity or a length of the reaction force spring 402 may be determined to cope with a maximum response delay time of the motor 300, and maximum pressure of the pedal cylinder 110 and an error thereof at that point in time.

In a case in which the motor 300 operates after the reaction force spring 402 is compressed, the reaction force spring 402 is extended again toward the original position (C section). Thereafter, the pressure in the pedal cylinder 110 is decreased and reaches a desired pedal effort (D section).

FIG. 5B is a graph illustrating a change in pedal effort with respect to a change in pedal stroke when the force of the motor 300 reaches a limit point.

Referring to FIG. 5B, the case in which no buffer structure is included and the case in which the buffer structure is included may be compared in terms of the change in pedal effort with respect to the change in pedal stroke at a knee-point at which the force of the motor 300 reaches the limit point.

In the case in which no buffer structure is included, if the force of the motor 300 reaches the limit point, the driving power of the motor 300 is constantly maintained, and the braking force is increased in accordance with an increase in pedal effort generated as the driver manipulates the brake pedal 104. In this case, similar to the case illustrated in FIG. 5A, the nut 215, which performs no motion, and the master piston 217 are spaced apart from each other. Thereby, the pressure in the pedal cylinder 110 is rapidly increased.

In contrast, in the case in which the buffer structure is included, even though the force of the motor 300 reaches the limit point, the reaction force spring 402 is compressed. Therefore, the pressure adjusting piston 403 is moved downward, such that the increase in pressure in the pedal cylinder 110 is mitigated, and the curve at the inflection point, which indicates the change in pedal effort, is smoothly formed (E section). In a case in which the reaction force spring 402 is maximally compressed, the curve has a gradient of the pedal effort with respect to the pedal stroke (F section), which is equal to a gradient in the case in which no buffer structure is included.

The electric brake booster according to the present disclosure, based on configurations of operating circuits thereof, may be configured to apply different pressure to front wheels and rear wheels or may be installed to serve as a modulator for applying different pressure to the four wheels.

An object and an effect of the present disclosure may be naturally understood or may become clearer from the following description. The object and the effect of the present disclosure are not restricted only by the following description. In addition, in the description of the present disclosure, the specific descriptions of publicly known technologies related with the present disclosure have been omitted when it is determined that the specific descriptions may unnecessarily obscure the subject matter of the present disclosure.

What is claimed is:

1. An electric brake booster comprising:
a first pressure device, which generates brake fluid pressure in accordance with a manipulation of a brake pedal;
a second pressure device, which is connected to the first pressure device through a flow path formed at one side of the second pressure device, wherein the second pressure device receives the brake fluid pressure from the first pressure device, and receives driving power of a motor as the motor connected to another side of the second pressure device operates;
a sensing unit, which is mounted in the motor and measures a displacement of the brake pedal and a rotation angle of the motor; and
a buffer device, which is connected to the second pressure device and prevents an increase in pressure of the brake pedal when the motor does not operate,
wherein the rotation of the motor is controlled in accordance with a displacement of the brake pedal.

2. The electric brake booster of claim 1, wherein the first pressure device further includes:
a push rod, which is rectilinearly moved in accordance with the manipulation of the brake pedal;
a pedal piston, which has one end coupled to the push rod and another end connected to a return spring such that the pedal piston reciprocally moves in accordance with the rectilinear motion of the push rod; and
a pedal cylinder, which receives a brake fluid from an oil reservoir and generates pressure by the reciprocating motion of the pedal piston.

3. The electric brake booster of claim 1, wherein the second pressure device further includes:
a boosting cylinder, which is connected to the first pressure device through a flow path;
a screw, which is coupled to the motor and rotated in the boosting cylinder in accordance with the operation of the motor;
a nut, which is coupled to the screw and rectilinearly moved in accordance with the rotational motion of the screw;
a master piston, which has one side in contact with the nut and another side connected to a return spring such that the master piston reciprocally moves in accordance with the rectilinear motion of the nut; and
a master cylinder, which receives a brake fluid from an oil reservoir and generates pressure by the reciprocating motion of the master piston.

4. The electric brake booster of claim 3, wherein the second pressure device is connected to an Electronic Stability Control (ESC) module or a brake caliper through a flow path formed in the master cylinder.

5. The electric brake booster of claim 1, wherein the sensing unit further includes:
a pedal sensor, which measures a displacement of the brake pedal; and
a motor sensor, which is mounted in the motor and measures a rotation angle of the motor.

6. The electric brake booster of claim 5, wherein the pedal sensor measures a displacement of any one of the brake pedal, a push rod, and a pedal piston.

7. The electric brake booster of claim 1, wherein the buffer device further includes:
a pressure adjusting cylinder, which is connected to a master cylinder of the second pressure device through a flow path; and
a pressure adjusting piston, which has a reaction force spring mounted at a lower end of the pressure adjusting piston and reciprocally moves in the pressure adjusting cylinder in accordance with brake fluid pressure generated by the first pressure device.
